(19) United States
(12) Patent Application Publication
(10) Pub. No.: US 2007/0199778 A1
(43) Pub. Date: Aug. 30, 2007

(54) Vented disc brake rotor

(76) Inventor: Kwangjin M. Lee, Novi, MI (US)

Correspondence Address: Delphi Technologies, Inc., Legal Staff - M/C 480-410-202, P.O. Box 5052, Troy, MI, 48007-5052, US

(21) Appl. No.: 11/711,194

(22) Filed: Feb. 27, 2007

Related U.S. Application Data
(60) Provisional application No. 60/777,048, filed on Feb. 27, 2006.

(51) Int. Cl. F16D 65/12

(52) U.S. Cl. 188/218 XL

(57) ABSTRACT

A vented brake disc rotor including a first annulus-shaped braking plate having an inner surface and an outer surface, a second annulus-shaped braking plate having an inner surface and an outer surface, the second braking plate being generally parallel with and spaced apart from the first braking plate, wherein the first and second braking plates define a central axis of rotation, a plurality of rib walls positioned between the inner surface of the first braking plate and the inner surface of the second braking plate, the plurality of rib walls connecting the first braking plate to the second braking plate and defining a plurality of channels between the first braking plate and the second braking plate, wherein the of the rib walls includes a radially outward tip and a radially inward portion, and a hat portion including a central mounting face and a hat wall extending generally axially from the mounting face, wherein the hat wall includes a plurality of support arms extending generally radially outward from the hat wall, wherein each of the support arms is connected to the radially inward portion of two adjacent rib walls.

The present application claims priority from U.S. Provisional Ser. No. 60/777,048 filed on Feb. 27, 2006, the entire contents of which are incorporated herein by reference.

### BACKGROUND

The present application is directed to vehicle braking systems and, more particularly, to vented disc brake rotors.

Disc brake systems generate a significant amount of heat during braking by converting the kinetic energy of the associated vehicle primarily to thermal energy resulting from friction between the brake pads and the braking surface of the rotors. As a result, the rotor temperature rises. An excessive temperature rise is undesirable since it may deform (e.g., warping or coning) the rotor and thereby degrade braking system performance.

To improve the performance and wear of disc brake systems, it is desirable to dissipate the heat generated during braking. Vented rotors dissipate heat using a plurality of air passages, known as channels, which are formed between the braking plate surfaces. As the rotor turns, air flows through the braking plate channels, absorbing and carrying away heat from the rotor, thereby cooling the rotor.

The concept of providing air flow ventilation from both the inboard and outboard sides of the rotors to enhance heat dissipation from the rotors is known. Unfortunately, the manufacture of vented disc brake rotors is quite complicated, and known rotor designs make it difficult to utilize conventional manufacturing processes, such as metal die-casting. In particular, with current rotor designs, the inboard and outboard vent inlet areas cannot both be enlarged without reducing the hat wall thickness and thereby reducing the stress load that can be transmitted from the braking surfaces to the hat wall and vehicle axle.

Accordingly, there is a need for a vented disc brake rotor having an enlarged heat dissipating area and an enhanced ability to transmit braking force.

### SUMMARY

In one aspect, the disclosed vented brake disc rotor may include a first annulus-shaped braking plate having an inner surface and an outer surface, a second annulus-shaped braking plate having an inner surface and an outer surface, the second braking plate being generally parallel with and spaced apart from the first braking plate, wherein the first and second braking plates define a central axis of rotation, a plurality of rib walls positioned between the inner surface of the first braking plate and the inner surface of the second braking plate, the plurality of rib walls connecting the first braking plate to the second braking plate and defining a plurality of channels between the first braking plate and the second braking plate, wherein the of the rib walls includes a radially outward tip and a radially inward portion, and a hat portion including a central mounting face and a hat wall extending generally axially from the mounting face, wherein the hat wall includes a plurality of support arms extending generally radially outward from the hat wall, wherein each of the support arms is connected to the radially inward portion of two adjacent rib walls.

Other aspects of the disclosed vented disc brake rotors will become apparent from the following description, the accompanying drawings and the appended claims.

### BRIEF DESCRIPTION OF THE DRAWINGS

FIG. 1 is a front perspective of the inboard side of one aspect of the disclosed vented disc brake rotor;

FIG. 2 is a front perspective view of the outboard side of the vented disc brake rotor of FIG. 1;

FIG. 3 is a front perspective view of the brake rotor of FIG. 1, partially broken away to show internal ventilation channels;

FIG. 4 is a front perspective view of the brake rotor of FIG. 2, partially broken away to show internal ventilation channels;

FIG. 5 is a detail perspective view of a support arm located generally at the axial midpoint between the braking plates of the rotor of FIG. 1;

FIG. 6 is a detail perspective view of a segment of the rotor of FIG. 1 showing a plurality of support arms located generally at the axial midpoint between the braking plates;

FIG. 7 is a detail side elevation, in-section, of the vented disc brake rotor of FIG. 1;

FIG. 8 is a detail schematic sectional view of the rotor of FIG. 1, showing airflow through the channel;

FIG. 9 is a detail perspective view of the rotor of FIG. 1, shown as a one-piece casting;

FIG. 10 is a detail perspective view of the rotor of FIG. 1, shown as a two-piece casting; and

FIG. 11 is a detail perspective view of another aspect of the disclosed vented disc brake rotor.

### DETAILED DESCRIPTION

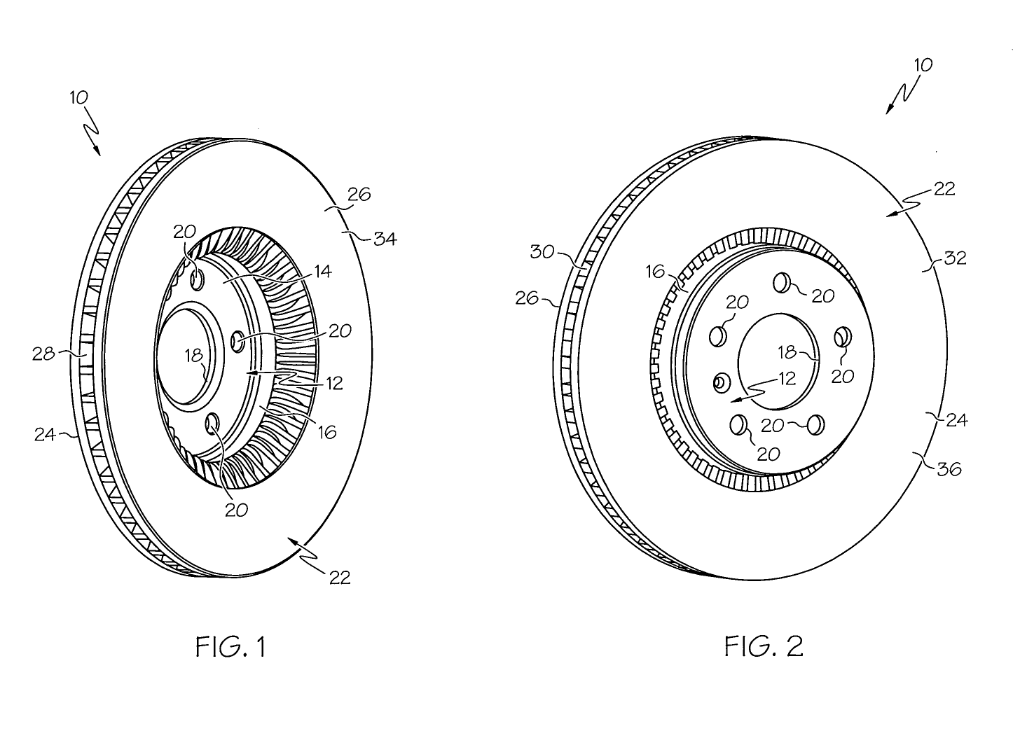

Referring to FIGS. 1 and 2, one aspect of the disclosed ventilated disc brake rotor, generally designated 10, may be utilized in a motor vehicle, such as a car, truck, or the like, or the landing gear of aircraft, or any other disc brake system. The ventilated disc brake rotor 10 may include an integral hat section 12 having a central mounting face 14 for mounting the rotor 10 on an associated vehicle drive member (not shown), such as a spindle or vehicle axle. The hat section 12 also may include a shoulder or hat wall 16 extending generally axially from the outer periphery of the mounting face 14. The hat wall 16 may be generally cylindrical in shape. Alternatively, the hat wall 16, or a portion thereof, may be inclined relative to the mounting face 14, having a conical shape, or may be curved. The mounting face 14 may be provided with a central pilot aperture 18 in which the spindle hub or the like may be closely received, and a plurality of circumferentially spaced apart fastener apertures 20 in which fasteners (not shown) may be received to mount the rotor 10 on an associated drive mechanism (not shown) in a conventional manner.

The brake rotor 10 may include a peripheral section 22 having a pair of annulus-shaped braking plates including a first braking plate 24 and a second braking plate 26, disposed in a spaced-apart relationship. The first braking plate 24 preferably extends radially from the hat wall 16. Preferably, the first braking plate 24 is the outboard braking plate with respect to the vehicle when the rotor 10 is mounted thereto, and the second braking plate 26 may be an inboard braking plate. The outboard 24 and inboard 26 braking plates may have substantially the same radial dimension and thickness, although the braking plates 24, 26 may be of a different radial and/or thickness dimension.

Each braking plate 24, 26 may have a respective inner surface 28, 30. The inner surfaces 28, 30 may face each other. Braking plates 24, 26 may include outer surfaces 32, 34, respectively. A flat annular braking surface 36 may be disposed on the outer surface 32 of the first braking plate 24 and a flat, annular braking surface 38 may be disposed on the outer surface 34 of the second braking plate 26. The braking surfaces 36, 38 may be disposed in a parallel relationship for contact with caliper brake pads (not shown).

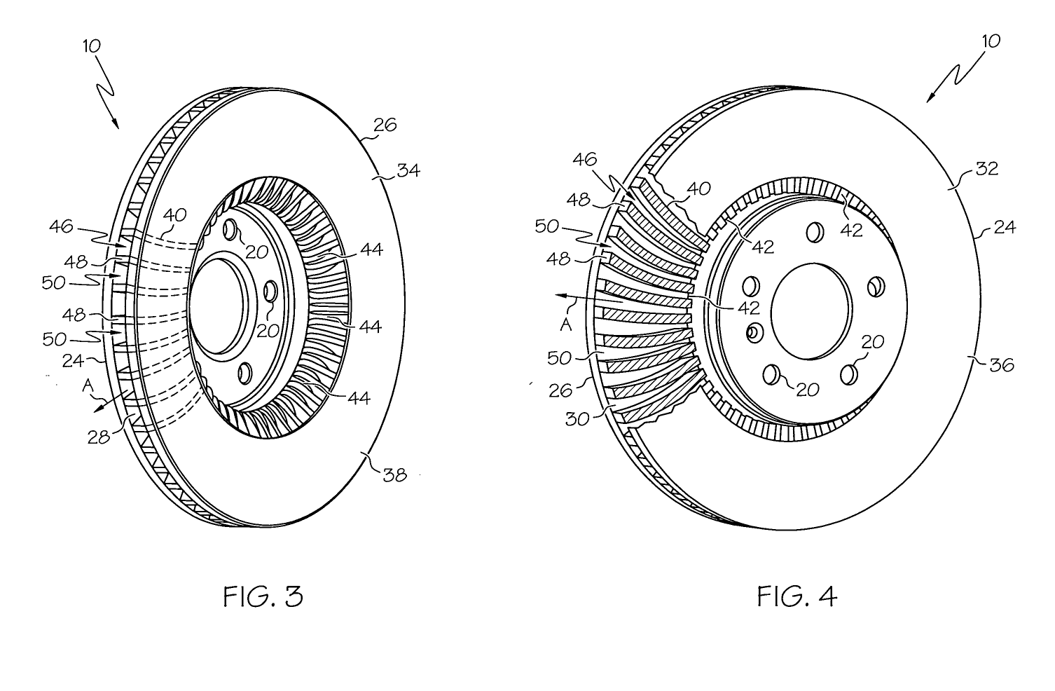

As shown in FIGS. 3 and 4, the rotor 10 may also include a plurality of braking plate ribs 40 disposed between the braking plates 24, 26. Each braking plate rib 40 may include a generally radially extending, circumferentially disposed rib wall 48 formed between the braking plates 24, 26 and thereby physically connecting the respective inner surfaces 28, 30 which face each other. As shown, each braking plate rib wall 48 may be generally disposed in a linear relationship between the radially inner ends of the braking plates 24, 26, and the radially outer ends of the braking plates 24, 26; although alternatively, each braking plate rib wall 48 may have a curved, arcuate, sinusoidal, or other geometric shape.

Each braking plate 24, 26 further may include a plurality of braking plate vent inlets 42, 44 disposed circumferentially at the radially inner ends of the braking plates 24, 26, respectively. A plurality of braking plate channels 46 are formed between the braking plates 24, 26 and are defined by the respective inner surfaces 28, 30 of the braking plates 24, 26 and the plurality of rib walls 48. Each braking plate vent inlet 42, 44 communicates with each braking plate channel 46 in a generally radial direction. The plurality of braking plate vent inlets 42, 44 are formed at the radially inner end of the respective braking plate channels 46.

Each channel 46 of the present invention may be open to both of the braking surfaces, 36, 38 giving a gapped or intermittent configuration to the braking surfaces as shown in FIGS. 3 and 4, and may be termed a “two-sided vent.” This configuration facilitates manufacturing by allowing the first and second braking surfaces 36, 38 to be integrally formed by a singular brake member by a suitable process, such as die-casting or squeeze-casting.

Each radially extending, circumferentially spaced braking plate channel 46 may terminate in a braking plate vent outlet 50 disposed at the radially outer periphery of the rotor 10. The direction of airflow through channel 46 during rotation of the rotor 10 is shown by arrow A. When the rotor 10 turns, ambient air moves between the braking plates 24, 26 by moving into the braking plate vent inlets 42, 44 and through the braking plate vents 46 and out through the braking plate vent outlets 50.

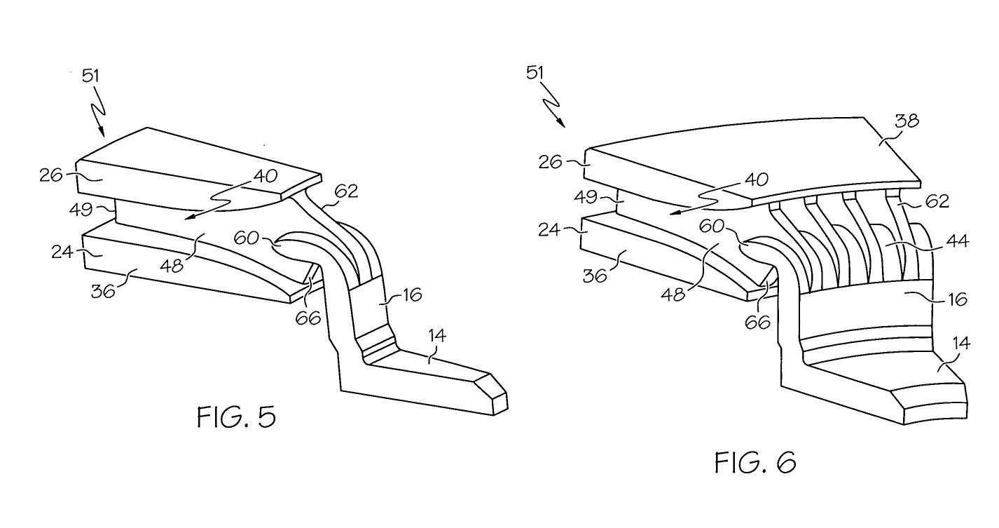

Referring to FIGS. 5 and 6, the rib wall 48 of each braking plate rib 40 extends radially outward to a tip 49 substantially adjacent an outer circumferential surface 51 of the rotor 10 and radially inward to a support arm 60. The support arm 60 may be disposed between braking plates 24, 26 and cantilevered away from the hat wall 16 in a generally radial direction. Each support arm 60 may be located generally at the axial midpoint between the braking plates 24, 26. Alternatively, support arm 60 may have an axial location either above the midpoint or below the midpoint such that rotor coning deformation may be reduced at operating temperatures.

The support arm 60 may be arcuate in shape and may consist of an upper brace 62 and a lower brace 66 and may be operable as a structural bridge between the braking plates 24, 26 and the hat wall 16 for gradually dissipating the axial applied forces generated by caliper brake pads. The upper brace 62 may connect the support arm 60 to the braking plate 26 and the hat wall 16. The lower brace 66 may connect the support arm 60 to the braking plate 24 and the hat wall 16. It should be noted that for a one-piece casting, no auxiliary fastening devices are required to secure the support arm 60 to the braces 62, 66, the braking plates 24, 26, or the hat wall 16.

The cross-sectional area defined by the support arm 60, the upper brace 62 and the lower brace 66 may provide a thickness that is significantly larger than the thickness of the hat wall 16, whereby the heat dissipation by conduction through the larger area occurs relatively efficiently. Consequently, the surfaces of the support arm 60, upper brace 62 and lower brace 66 may operate as cooling fins to increase the surface area available for heat transfer between highly conductive metal walls and poorly conducting fluids, such as air. Furthermore, the larger cross-sectional area provided by the support arm 60, the upper brace 62 and the lower brace 66 may enhance the structural support between the hat wall 16 and the braking plates 24, 26 by eliminating narrow regions prone to initiate localized structural defects (i.e., stress cracking, etc.).

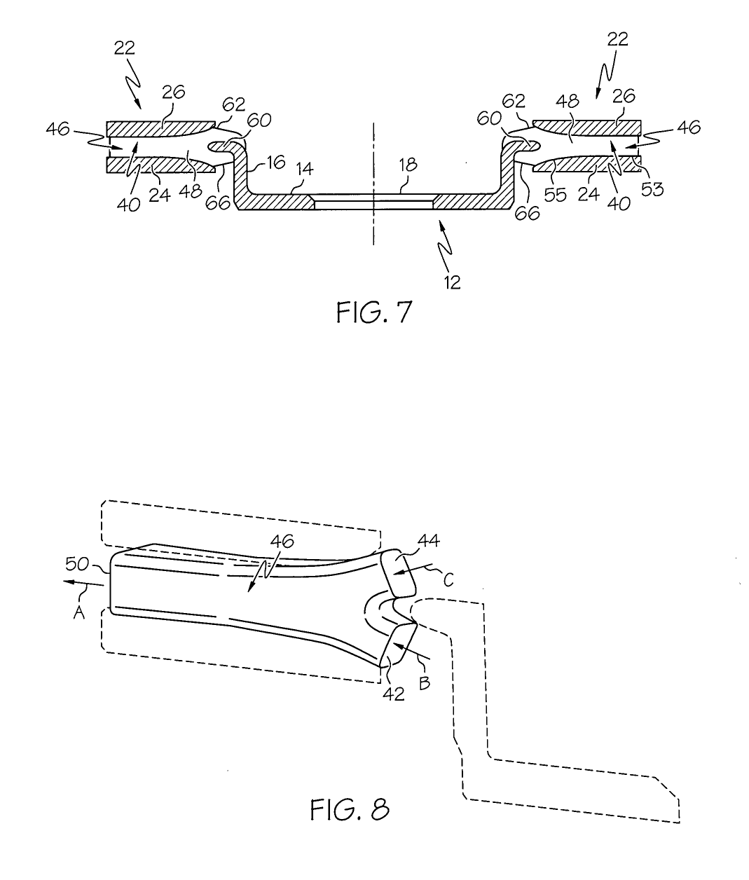

Referring to FIG. 7, when the rotor is viewed in section, the braking plate ribs 40 are generally arcuate and taper in thickness from the region 53 adjacent the radially outer ends of the ribs outwardly to the region 55 adjacent the radially inner ends of the ribs. Consequently, the braking plate vent channels 46 may have a generally arcuate cross-sectional area as illustrated in FIG. 8. It should be noted that, generally, about the same cross-sectional area may be maintained for the vent channels 46 from a radially central position to a radially inner end of the rib 40, thereby enhancing the incoming airflow. In conventional vented brake rotors, vent channel cross-sectional area (not shown) typically decreases from the radially outer ends of the vent channel to the radially inner ends of the vent channel, thereby restricting the incoming airflow.

The direction of airflow into the inlets 42, 44 is shown by the arrows B and C, respectively as illustrated in FIG. 8. Furthermore, the direction of air flow from the outlet 50 is shown by arrow A. While not bound by a single theory, it is believed that the airflow between the braking plates 24, 26 may be at least directly proportional to displacement between the plates and, more particularly, the airflow between the brake plates may decrease or increase in a manner proportional to the third power of the change in displacement between the plates. This non-binding theory was set forth in U.S. Pat. No. 5,780,748 to Barth, the entire contents of which are incorporated herein by reference.

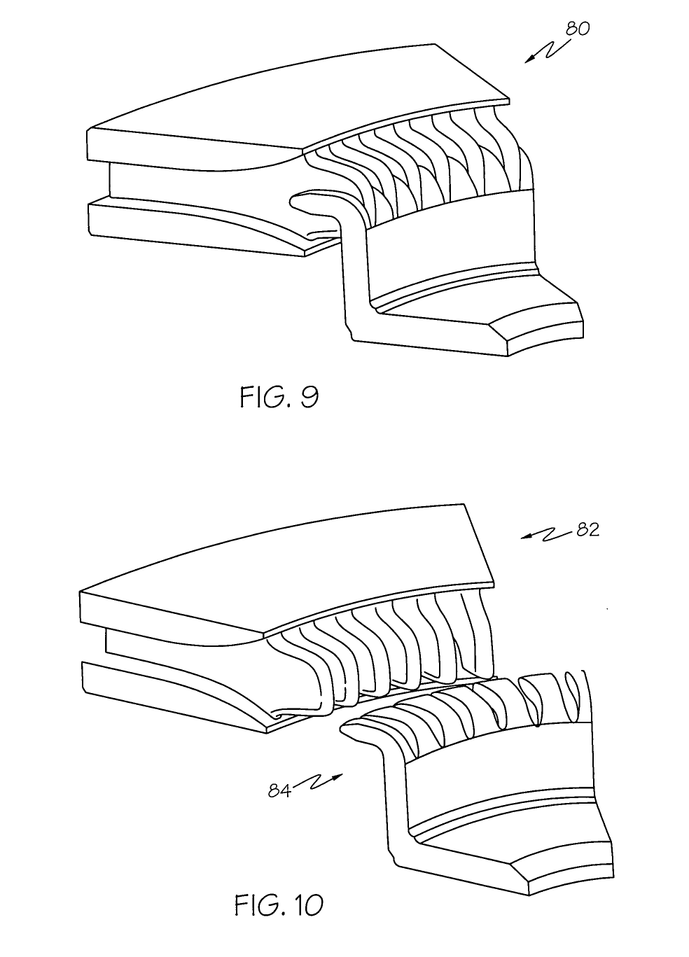

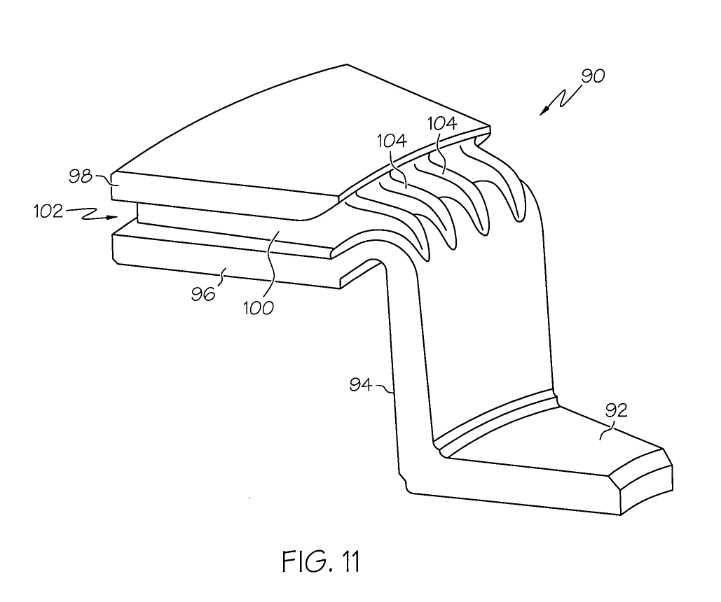

The brake rotor 10 may be preferably cast as an unitary, one-piece rotor, although separate components may be cast and assembled to achieve the finished rotor. A one-piece casting, generally denoted 80, is shown in FIG. 9. For example, a low-alloy iron/steel material having a density of about 0.26 to 0.28 pounds per cubic inch may be used for a one-piece casting having moderate performance requirements. In general, a metallic matrix composite having a density of about 0.4 to 0.5 pounds per cubic inch may be used for a one-piece casting having highly demanding performance requirements. A two-piece casting, as shown in FIG. 10, may include a hat section casting 84 and an annular peripheral section casting 82. The rotors may be manufactured as a two-piece casting thereby allowing a weight savings through use of a lower density material for the hat section, such as aluminum alloy having a density of about 0.096 to 0.102 pounds per cubic inch.

In one aspect, the vented rotor 10 shown in FIGS. 1 and 2 may formed by the following method. First, the rotor 10 may be cast using any conventional casting method from a suitable material, such as a metallic matrix composite or the like, to the desired configuration including at least, the hat section and the annular peripheral section. The annular peripheral section may include braking plates 24, 26 and the plurality of braking plate ribs 40.

The rotor casting may be cooled and then subjected to a finish machining step. The finish machining step may include drilling the central aperture 18 and the plurality of fastener apertures 20, although these apertures may also be formed in the initial casting. The finish machining step may also include machining each of the braking surfaces 36, 38 of each of the braking plates 24, 26, respectively. Alternatively, the process may include a rough machining step before final finish machining.

Referring to FIG. 12, an alternative aspect of the disclosed vented disc brake rotor, generally designated 90, may include a central mounting face 92, a hat wall 94 extending from the periphery of the mounting face 92, a first braking plate 96 extending from the hat wall 94 and a second braking plate 98. The braking plates 96, 98 may be separated from each other by a plurality of braking plate ribs 100, thereby defining a plurality of radially extending braking plate channels 102 between the braking plates 96, 98 and ribs 100. Each braking plate channel 102 may include a brake plate vent inlet 104 that communicates with each brake plate channel 102 in a generally radial direction, as described above.

The brake plate channel 102 may be open to brake plate 98, but closed to brake plate 96, such that each brake plate channel 102 may dissipate the heat from only one of the braking plates 96, 98 and may be termed a “one-sided vent.” As the rotor 90 turns, air flows through the braking plate channels 102 absorbing and carrying away heat from, and thereby cooling, the brake plates 96, 98. Furthermore, the rotor 90 may be operable to transmit braking force torque from calipers through the hat wall 94 and to an associated vehicle axle. The vented disc brake rotor 90 may be manufactured by a one-piece or two-piece casting in the manner described earlier.

Accordingly, the disclosed vented disc brake rotors provide a plurality of radially extending, circumferentially spaced airflow channels open to at least one braking surface and having an enlarged heat dissipation area between the braking plates, while simultaneously enhancing the ability of the rotor to transmit braking force torque applied by the brake calipers through the hat wall and to the vehicle axle. The disclosed vented disc brake rotors may be manufactured as a unitary, one-piece casting, or as a two-piece casting, thereby allowing a weight savings through use of a lower density material for the hat section.

Although various aspects of the disclosed vented disc brake rotors have been shown and described, modifications may occur to those skilled in the art upon reading the specification. The present application includes such modifications and is limited only by the scope of the claims

1. A vented brake disc rotor comprising:
a first annulus-shaped braking plate having an inner surface and an outer surface;
a second annulus-shaped braking plate having an inner surface and an outer surface, said second braking plate being generally parallel with and spaced apart from said first braking plate, wherein said first and said second braking plates define a central axis of rotation;
a plurality of rib walls positioned between said inner surface of said first braking plate and said inner surface of said second braking plate, said plurality of rib walls connecting said first braking plate to said second braking plate and defining a plurality of channels between said first braking plate and said second braking plate, wherein each of said plurality of rib walls includes a radially outward tip and a radially inward portion; and
a hat portion including a central mounting face and a hat wall extending generally axially from said mounting face, wherein said hat wall includes a plurality of support arms extending generally radially outward from said hat wall, wherein each of said support arms is connected to said radially inward portion of two adjacent ones of said plurality of rib walls.

2. The rotor of claim 1 wherein said outer surfaces of said first and said second braking plates include a braking surface.

3. The rotor of claim 1 wherein said first and said second braking plates have generally the same radial dimension and thickness.

4. The rotor of claim 1 wherein each of said plurality of rib walls extends generally radially with respect to said central axis of rotation.

5. The rotor of claim 1 wherein each of said plurality of rib walls extends at an angle relative to a ray extending radially with respect to said central axis of rotation.

6. The rotor of claim 1 wherein each of said plurality of channels extends in a generally linear direction.

7. The rotor of claim 1 wherein said hat wall is generally cylindrical in shape.

8. The rotor of claim 1 wherein said central mounting face defines an aperture.

9. The rotor of claim 1 wherein said central mounting face defines a plurality of fastener apertures.

10. The rotor of claim 1 wherein each of said plurality of support arms extends between said first and said second braking plates.

11. The rotor of claim 1 wherein each of said plurality of support arms is generally aligned with an associated one of said plurality of channels.

12. The rotor of claim 1 wherein each of said plurality of support arms is positioned generally centrally between said first and said second braking plates.

13. The rotor of claim 1 wherein said first braking plate, two adjacent ones of said plurality of rib walls and an associated one of said plurality of support arms define a first braking plate vent inlet.

14. The rotor of claim 1 wherein said second braking plate, two adjacent ones of said plurality of rib walls and an associated one of said plurality of support arms define a second braking plate vent inlet.

15. The rotor of claim 1 wherein each of said plurality of support arms includes an upper brace connected to said first braking plate and a lower brace connect to said second braking plate.

16. The rotor of claim 1 wherein said first braking plate, said second braking plate, said plurality of rib walls and said hat portion are each part of a monolithic structure.

17. The rotor of claim 16 wherein said monolithic structure is formed from cast iron.

18. The rotor of claim 1 wherein said plurality of channels define a fluid flow path from said radially inward portion to said radially outward tip,

19. The rotor of claim 1 wherein said radially inward portion of said plurality of rib walls extends radially inward beyond said first and said second braking plates

20. A vented brake disc rotor comprising:
a first annulus-shaped braking plate having an inner surface and an outer surface, said outer surface including a braking surface;
a second annulus-shaped braking plate having an inner surface and an outer surface, said outer surface including a braking surface, said second braking plate being generally parallel with and spaced apart from said first braking plate, wherein said first and said second braking plates define a central axis of rotation;
a plurality of rib walls positioned between said inner surface of said first braking plate and said inner surface of said second braking plate and extending generally radially with respect to said central axis of rotation, said plurality of rib walls connecting said first braking plate to said second braking plate and defining a plurality of channels between said first braking plate and said second braking plate, wherein each of said plurality of rib walls includes a radially outward tip and a radially inward portion; and
a hat portion including a central mounting face and a generally cylindrical hat wall extending generally axially from a periphery of said mounting face, wherein said hat wall includes a plurality of support arms extending generally radially outward from said hat wall, wherein each of said support arms is connected to said radially inward portion of two adjacent ones of said plurality of rib walls,
wherein said first braking plate, said second braking plate, said plurality of rib walls and said hat portion are each part of a monolithic structure.
